(19) United States
(12) Patent Application Publication
(10) Pub. No.: US 2015/0081633 A1
(43) Pub. Date: Mar. 19, 2015

(54) DATA SYNCHRONIZATION METHOD AND DEVICE

(71) Applicant: TENCENT TECHNOLOGY (SHENZHEN) COMPANY LIMITED, Shenzhen (CN)

(72) Inventors: Ke SU, Shenzhen (CN); Lei ZHENG, Shenzhen (CN); Lei JIANG, Shenzhen (CN); Juguo YOU, Shenzhen (CN)

(21) Appl. No.: 14/553,699

(22) Filed: Nov. 25, 2014

Related U.S. Application Data
(63) Continuation of application No. PCT/CN2012/087006, filed on Dec. 20, 2012.

(30) Foreign Application Priority Data
May 28, 2012 (CN) 201210168170.1

(51) Int. Cl. G06F 17/30; H04L 29/06; G06F 11/14

(52) U.S. Cl. CPC G06F 17/30575; G06F 11/1464; H04L 63/08
USPC 707/634

(57) ABSTRACT

The present disclosure provides a data synchronization method and device, relating to the field of data processing. The method includes: sending a synchronization request to a backup server by a client, the synchronization request including a client data version number and client synchronization data; receiving the synchronization request and determining whether the client data version number is consistent with a local data version number by the backup server; updating local data according to the client synchronization data on condition that the client data version number is consistent with the local data version number; and sending the local data version number and the local data to the client on condition that the client data version number is not consistent with local data version number. By using a version number mechanism, the present disclosure can manage the backup data in the backup server and the client synchronization data at the client. In this way, it ensures that the data in multiple devices of a user is synchronized to a same backup server.

### CROSS REFERENCE TO RELATED APPLICATIONS

This application is a continuation of international Patent Application Number PCT/CN2012/087006, entitled “Data Synchronization Method, System and Device”, filed Dec. 20, 2012, which claims the benefit of and priority to Chinese Patent Application No. 201210168170.1, entitled “Data Synchronization Method, System and Device”, filed May 28, 2012, both of which said applications are incorporated herein in their entirety by reference.

### TECHNICAL FIELD

The present disclosure relates to data processing, and particularly to a data synchronization method and device.

### BACKGROUND

With the development of Internet, nowadays browsers have become one of the most broadly used applications in daily life.

When a browser is used, a great amount of private data may be produced based on a user's personal habits, such as accumulation of bookmarks after a long time, homepages set by the user, operation gestures set by the user and historical records, etc. These data is very valuable information for the user, and therefore data loss due to equipment theft, hardware failure or virus attacks could be a painful experience. For this reason, currently there is a conventional method of data synchronization: first, a device with a browser running establishes communication with a backup server at a preconfigured time interval; second, after the communication is established, the device synchronizes the data in the browser to the backup server. Thus, even if the data is lost, the user still can retrieve the data from the backup server.

In the course of realizing the present disclosure, the inventor finds that at least the following defects exist in the existing solution.

In practical use, a user may use multiple devices to access networks, such as using a desktop computer located at his office, a laptop located at his home and a smart phone with him, etc. The existing solution can only complete a process of synchronizing data from one device to one backup server, but is unable to complete a process of synchronizing data from the multiple devices of the user to one backup server, namely, a “multiple-to-one” synchronization process. Furthermore, the existing data synchronization solution is likely to incur data synchronization disorder in the “multiple-to-one” synchronization process.

### SUMMARY

To solve the data synchronization disorder occurring during the synchronization process of multiple devices to a backup server, the present disclosure provides a data synchronization method, system and device.

In an aspect, the present disclosure provides a method of data synchronization, including: sending a synchronization request to a backup server by a client, the synchronization request including a client data version number and client synchronization data; receiving the synchronization request and determining whether the client data version number is consistent with a local data version number by the backup server; updating local data according to the client synchronization data on condition that the client data version number is consistent with the local data version number; and sending the local data version number and the local data to the client on condition that the client data version number is not consistent with the local data version number.

Further, the client synchronization data includes: synchronization data, each piece of synchronization data including data identification, a synchronization mode and synchronization content; in which the synchronization mode includes any one of the following modes: an adding mode, to add content corresponding to the data identification according to the synchronization content; a modifying mode, to modify the content corresponding to the data identification according to the synchronization content; a deleting mode, to delete the content corresponding to the data identification according to the synchronization content; and a maintaining mode, to maintain the content corresponding to the data identification unchanged.

Further, updating the local data according to the client synchronization data includes: updating backup data in the local data according to the synchronization mode of each piece of synchronization data in the client synchronization data; in which the local data includes the backup data, and each piece of the backup data includes the data identification and content corresponding to the data identification.

Further, after updating the local data according to the client synchronization data, the method further includes: generating a new local data version number and sending the new local data version number to the client by the backup server; and receiving the new local data version number and updating a value of the client data version number to a value of the new local data version number by the client.

Further, after sending the local data version number and the local data to the client, the method further includes: receiving the local data version number and the local data sent from the backup server by the client; and deleting the client synchronization data, saving the local data, and updating a value of the client data version number to a value of the local data version number by the client.

Further, before sending the synchronization request to the backup server by the client, the method further includes: using preconfigured authentication information to log into the backup server by the client; determining whether this is a first login of the client by the backup server; creating the local data version number and the local data corresponding to the preconfigured authentication information on condition that the backup server determines that this is the first login of the client; and searching for the local data version number and the local data corresponding to the preconfigured authentication information on condition that the backup server determines this is not the first login of the client.

In another aspect, an example of the present disclosure provides a system of data synchronization. The system includes a client and a backup server; the client is configured to send a synchronization request to the backup server; the synchronization request including a client data version number and client synchronization data; and the backup server is configured to receive the synchronization request, and determine whether the client data version number is consistent with a local data version number; on condition that the client data version number is consistent with the local data version number, update local data according to the client synchronization data; and on condition that the client data version number is not consistent with the local data version number, send the local data version number and the local data to the client.

In another aspect, an example of the present disclosure provides a client, including: a request sending module, to send a synchronization request to a backup server; the synchronization request including a client data version number and client synchronization data; a data receiving module, to receive a local data version number and local data sent from the backup server; and a data updating module, to delete the client synchronization data, save the local data, and update a value of the client data version number to a value of the local data version number.

Further, the request sending module is configured to send the synchronization request to the backup server; the synchronization request comprises the client data version number and the client synchronization data; each piece of synchronization data includes data identification, a synchronization mode and synchronization content; in which the synchronization mode includes any one of the following modes: an adding mode, to add content corresponding to the data identification according to the synchronization content; in which the modifying mode is configured to modify the content corresponding to the data identification according to the synchronization content; the deleting mode is configured to delete the content corresponding to the data identification according to the synchronization content; and the maintaining mode is configured to maintain the content corresponding to the data identification.

Further, the client also includes a version receiving module and a version updating module; the version receiving module is configured to receive a new local data version number; and the version updating module is configured to update the value of the client data version number to a value of the new local data version number.

Further, the client further includes: a login module, to use preconfigured authentication information to log into the backup server.

In another aspect, the backup server includes: a request receiving module, to receive a synchronization request from a client, the synchronization request including a client data version number and client synchronization data; a version determination module, to determine whether the client data version number is consistent with a local data version number; a data updating module, to update local data according to the client synchronization data on condition that the client data version number is consistent with the local data version number; and a data sending module, to send the local data version number and the local data to the client on condition that the client data version number is not consistent with the local data version number.

Further, the data updating module is configured to update backup data in the local data according to a synchronization mode of each piece of the client synchronization data; and the local data includes the backup data, and each piece of the backup data includes data identification and content corresponding to the data identification.

Further, the backup server further includes: a version generation module; and the version generation module is configured to generate a new local data version number and send the new local data version number to the client.

Further, the backup server further includes: a login determination module, a data creation module, and a data searching module; in which the login determination module is configured to determine whether this is a first login of the client; the data creation module is configured to create the local data version number and the local data corresponding to the preconfigured authentication information on condition that the backup server determines that this is the first login of the client; and the data searching module is configured to search the local data version number and the local data corresponding to the preconfigured authentication information on condition that the backup server determines that this is not the first login of the client.

By using a version number mechanism to manage the backup data in the backup server and the client synchronization data at the client, the examples of the present disclosure solve the problem that during the process of synchronizing multiple devices and a backup server, data synchronization disorder may occur, and ensure that the data in multiple devices of a user can be synchronized to a same backup server. Therefore, overall consistency of the data is guaranteed, even if the user is using multiple devices across platforms.

### BRIEF DESCRIPTION OF THE DRAWINGS

In order to illustrate the technical scheme of the present disclosure, hereafter a brief introduction would be given to the figures used in the detailed description of examples. Obviously, the figures below are merely some of the examples of the present disclosure. For those skilled in the art, they could obtain other figures basing on the current figures without any creative work.

FIG. 1 illustrates a method flow chart of a method of data synchronization provided in example I of the present disclosure;

FIG. 2 illustrates a method flow chart of a method of data synchronization provided in example II of the present disclosure;

FIG. 3 illustrates a structural schematic diagram of a system of data synchronization provided in example III of the present disclosure;

FIG. 4 illustrates a structural block diagram of a client provided in example IV of the present disclosure;

FIG. 5 illustrates another structural block diagram of the client provided in example IV of the present disclosure;

FIG. 6 illustrates another structural block diagram of the client provided in example IV of the present disclosure;

FIG. 7 illustrates a structural block diagram of a backup server provided in example V of the present disclosure;

FIG. 8 illustrates another structural block diagram of the backup server provided in example V of the present disclosure; and

FIG. 9 illustrates another structural block diagram of the backup server provided in example V of the present disclosure.

### DETAILED DESCRIPTION

To make the objectives, technical solutions and advantages of the present disclosure clearer and more understandable, the present disclosure will be described more fully in combination with embodiments and the accompanying drawings.

### Example I

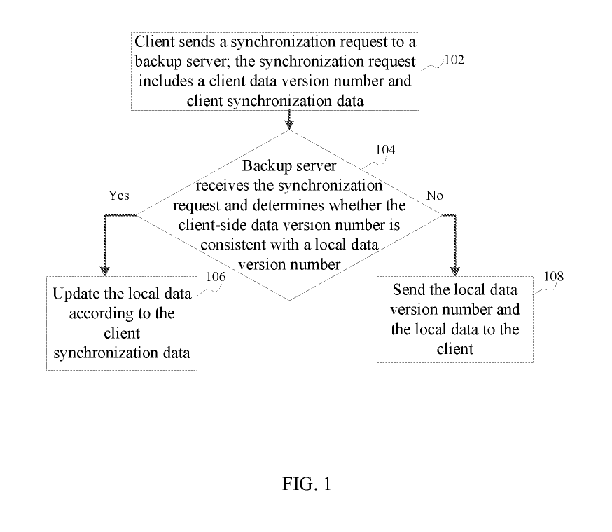

Referring to FIG. 1, it illustrates a method flow chart of a method of data synchronization provided in example I of the present disclosure. The data synchronization method may include the following process.

At block 102, a client sends a synchronization request to a backup server; the synchronization request includes a client data version number and client synchronization data.

Taking data that needs to be backed up being user data in a browser as an example, the client may send a synchronization request every a preconfigured time interval, or each time when the browser is opened or closed, or each time when the user data changes. The synchronization request may include a client data version number and client synchronization data. The client data version number is a data version number sent from the server to the client in a last data synchronization process. For instance, if the last data synchronization process is completed at 01:00 AM, on 1 Jan. 2012, then the client data version number can be 201201010100.

At block 104, the backup server receives the synchronization request and determines whether the client data version number is consistent with a local data version number.

The backup server can receive the synchronization request and determine whether the client data version number is consistent with the local data version number. The local data version number refers to a version number generated last time when the backup server is synchronized with a client. Herein the client can be the client in Block 102 or another client used by the user. For instance, if the last time when the backup server is synchronized with the client is at 11:54 AM, on 2 Jan. 2012, then the local data version number may be 201201021154.

At block 106, if the client data version number is consistent with the local data version number, then the local data is updated according to the client synchronization data.

If the backup server determines that the client data version number is consistent with the local data version number, then this means that the client synchronization data uploaded by the client this time is data that has changed on the basis of the local data saved on the backup server. In this case, the backup server can update the local data according to the client synchronization data. For instance, when the client sends a synchronization request at 12:03 AM on 3 Jan. 2012, the synchronization request including a client data version number 201201021154, and if the local data version number on the backup server is also 201201021154, then it means that the client synchronization data uploaded by the client this time has changed by 12:03 AM, on 3 Jan. 2012 on the basis of the local data backed up in synchronization on the backup server at 11:54 AM, on 2 Jan. 2012. In this case, the backup server can update the local data according to the client synchronization data.

At block 108, if the client data version number is not consistent with the local data version number, then a local data version number and local data are sent to the client.

If the backup server determines that the client data version number is not consistent with the local data version number, then this means that the original data at the client is relatively old. In this case, the backup server does not accept the client synchronization data uploaded by the client. For instance, when the client sends a synchronization request at 12:03 AM, on 3 Jan. 2012, with the synchronization request including a client data version number 201201010100, and if the local data version number on the backup server is 201201021154, then it means that the client synchronization data uploaded by the client this time has changed by 12:03 AM, on 3 Jan. 2012 on the basis of the local data backed up in synchronization on the backup server at 01:00 AM, on 1 Jan. 2012, while the local data on the backup server is synchronized by another client at 11:54 AM, on 2 Jan. 2012. In this case, the backup server does not accept the client synchronization data uploaded by the client but sends a local data version number and local data instead. That is, the backup server sends the local data version number 201201021154 and the saved local data on the backup server. In this way, data disorder can be avoided when different clients synchronize data with one backup server.

To sum up, by using a version number mechanism maintained by the backup server, the data synchronization method provided in example I can manage the backup data on the backup server and the client synchronization data at the client. In this way, it solves the problem that during the process of synchronizing multiple devices and a backup server, data synchronization disorder may occur, and ensures that data on multiple devices of a user can be synchronized to a same backup server. Therefore, it ensures overall consistency of the data, even if the user is using multiple devices across platforms.

### Example II

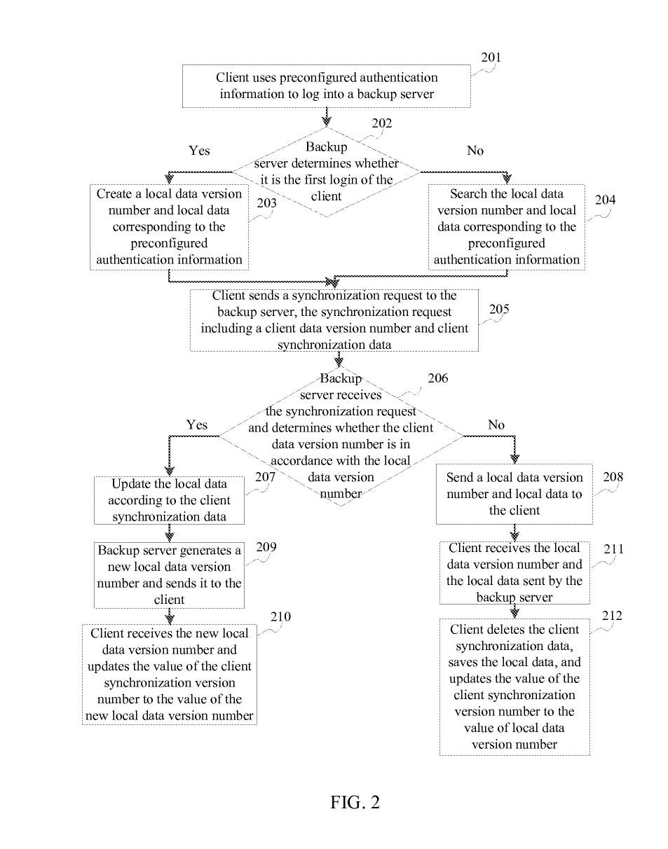

Referring to FIG. 2, it illustrates a method flow chart of a method of data synchronization provided in example II of the present disclosure. The data synchronization method may include the following process.

At block 201, a client uses preconfigured authentication information to log into a backup server.

The preconfigured authentication information could be a set of username and password, and the username and the password are obtained via a process of the user using a client to register with the backup server. When the user needs to use multiple different clients to synchronize with the backup server, he can use this set of username and password to log into the backup server to instruct that client synchronization data on the multiple clients is always synchronized with same local data corresponding to the set of user name and password. Of course, in different examples, the preconfigured authentication information could also be other information that can be used to uniquely identify the user, such as an email address of the user, a cell phone number of the user, an ID card number of the user, etc.

Taking for instance that the data to be backed up is user data in a browser, a client can use the set of username and password to log into the backup server each time when the browser is opened.

At block 202, the backup server determines whether it is a first login of the client.

When receiving login of the client, the backup server may determine whether it is the first login of the client. If yes, then block 203 is entered; and if no, then block 204 is entered. This block can be realized by using the backup server to determine the number of logins of the preconfigured authentication information.

At Block 203, if the backup server determines that this is the first login of the client, then it creates a local data version number and local data corresponding to the preconfigured authentication information.

If the backup server determines that this is the first login of the client, which means that the backup server does not have the local data version number and local data corresponding to the preconfigured authentication information. In this case, the backup server could create a local data version number and local data corresponding to the preconfigured authentication information. The initially created local data version number and the local data could be void.

At block 204, if the backup server determines that this is not the first login of the client, then it searches a local data version number and local data corresponding to the preconfigured authentication information.

If the backup server determines this is not the first login of the client, then the backup server locally already has a local data version number and local data corresponding to the preconfigured authentication information. In this case, the backup server could search the local data version number and the local data corresponding to the preconfigured authentication information.

At block 205, the client sends a synchronization request to the backup server, the synchronization request including a client data version number and client synchronization data.

After logging into the backup server, the client could send a synchronization request to the backup server. The synchronization request includes a client data version number and client synchronization data. If this is the first login of the client to the backup server, then both of the client data version number and the client synchronization data could be void. It should be noted herein that the client may send a synchronization request every a preconfigured time interval, or at other moments such as each time when a browser is opened, each time when the browser is closed, or each time when user data changes. For instance, the client may not only send a synchronization request each time when it opens the browser to update the internal user data to a latest version, but also sends a synchronization request each time when it closes the browser in order to update the newly generated client synchronization data to the backup server.

If this is not the first login of the client to the backup server, then it means that the client has had a synchronization process with the backup server. And in a last data synchronization process, a data version number has been sent to the client by the backup server, and the data version number can be saved as the client data version number by the client. For instance, if the last synchronization process was conducted at 01:00 AM, on 1 Jan. 2012, then the client data version number may be 201201010100. Meanwhile, the backup server has sent data to the client in the last data synchronization process, and the client can save the data and generate the client synchronization data. The client synchronization data may include at least one piece of synchronization data; each piece of synchronization data includes data identification, a synchronization mode and synchronization content.

In a specific instance, a piece of data has been sent by the backup server to the client in the last data synchronization process. The data could be bookmarks saved by a user through a browser, e.g.:

TABLE 2-1

| Data | | |
|---|---|---|
| identification, | Bookmark name | Bookmark address |
| 0001 | Moonlight Blog | http://www.williamlong.info/ |
| 0002 | Faded Ink | http://www.mifengtd.cn/ |
| 0003 | Studying of Fighting | http://www.read.org.cn/ |
| | Falcon | |

After the client is used, the generated client synchronization data could be as follows:

TABLE 2-2

| Data | Synchronization | |
|---|---|---|
| identification, | mode | Synchronization content |
| 0001 | Deleting mode | |
| 0002 | Maintaining mode | |
| 0003 | Modifying mode | Modify “Studying of Fighting |
| | | Falcon” to “Fighting Falcon” |
| 0004 | Adding mode | Bookmark Name: Sina.com, |
| | | Bookmark Address: |
| | | www.163.com.cn |
| 0005 | Adding mode | Bookmark Name: Taobao.com, |
| | | Bookmark Address: |
| | | www.taobao.com |

According to the above table, the synchronization mode could be any one of the following modes: an adding mode, configured to add content corresponding to the data identification according to the synchronization content, e.g. the newly-added “Sina.com” and “Taobao.com” bookmarks in the above table; a modifying mode, configured to modify the content corresponding to the data identification according to the synchronization content, e.g., modifying the content in data identification 0003 in the above table; a deleting mode, configured to delete the content corresponding to the data identification according to the synchronization content, e.g., deleting the content in data identification 0001 in the above table; a maintaining mode, configured to maintain the content corresponding to the data identification unchanged, e.g. maintaining the content in data identification 0002 in the table above unchanged.

It should be noted herein that, when the synchronization mode is the maintaining mode or the deleting mode, the synchronization content could be void. And the synchronization content may include relevant data items (not necessarily all data items) only when the synchronization mode is the modifying mode or the adding mode, and thereby reducing data traffic during the uploading operation of the client.

At block 206, the backup server receives the synchronization request and determines whether the client data version number is consistent with the local data version number. If yes, then block 203 is entered; and if no, then block 204 is entered.

The backup server receives the synchronization request and determines whether the client data version number is consistent with the local data version number. The local data version number refers to a version number generated during the last synchronization process between the backup server and the client. Herein the client can be the client in block 204, or another client used by the user. For instance, if the last synchronization between the backup server and the client is conducted at 11:54 AM, on 2 Jan. 2012, then the local data version number may be 201201021154.

At block 207, if the client data version number is consistent with the local data version number, then the local data is updated according to the client synchronization data.

If the backup server determines that the client data version number is consistent with the local data version number, which means that the client synchronization data uploaded by the client this time is data that has changed on the basis of the local data saved on the backup server. In this case, the backup server can update the local data according to the client synchronization data. For instance, when the client sends a synchronization request at 12:03 AM, on 3 Jan. 2012, the synchronization request includes a client data version number 201201021154, and if the local data version number on the backup server is also 201201021154, then it means that the client synchronization data uploaded by the client this time has changed by 12:03 AM, on 3 Jan. 2012 on the basis of the local data saved in the backup server at 11:54 AM, on 2 Jan. 2012. In this case, the backup server can update the local data according to the client synchronization data.

More specifically, the backup server can update the backup data in the local data according to the synchronization mode of each piece of synchronization data in the client synchronization data, in which the local data includes zero to many pieces of backup data, and each piece of backup data includes data identification and content corresponding to the data identification. Suppose that the local data on the backup server is as shown in table 2-1, and the client synchronization data uploaded by the client is as shown in table 2-2, then the local data after being updated by the backup server according to the client synchronization data could be as follows:

TABLE 2-3

| Data | | |
|---|---|---|
| identification | Bookmark name | Bookmark address |
| 0002 | Faded Ink | http://www.mifengtd.cn/ |
| 0003 | Studying of Fighting Falcon | http://www.read.org.cn/ |
| 0004 | Sina.com | www.163.com.cn |
| 0005 | Tabao.com | www.taobao.com |

At block 209, the backup server generates a new local data version number and sends it to the client.

After the backup server updates the local data according to the client synchronization data, the backup server could generate a new local data version number, e.g. 201201031203, and then the backup server could send the new local data version number to the client.

At block 210, the client receives the new local data version number and updates the value of the client data version number to the value of the new local data version number.

The client receives the new local data version number sent from the backup server and updates the value of the client data version number (201201021154) to the value of the new local data version number (201201031203).

Back to the determination process in block 206, and if the client data version number is not consistent with the local data version number, then block 208 is entered.

At Block 208, if the client data version number is not consistent with the local data version number, then a local data version number and local data is sent to the client.

If the backup server determines that the client data version number is not consistent with the local data version number, then this means that the original data at the client is relatively old. In this case, the backup server does not accept the client synchronization data uploaded by the client, but sends the local data version number and the local data to the client. For instance, when the client sends a synchronization request at 12:03 AM, on 3 Jan. 2012, the synchronization request including a client data version number 201201010100, if the local data version number on the backup server is 201201021154, then it means that the client synchronization data uploaded by the client this time has changed by 12:03 AM, on 3 Jan. 2012 on the basis of the local data saved in the backup server at 01:00 AM, on 1 Jan. 2012, whereas the local data on the backup server is synchronized with another client at 11:54 AM, on 2 Jan. 2012. In this case, the backup server does not accept the client synchronization data uploaded by the client, but sends a local data version number and local data instead. That is to say, the backup server sends the local data version number 201201021154 and the local data saved in the backup server.

At block 211, the client receives the local data version number and the local data sent by the backup server.

At block 212, the client deletes the client synchronization data, saves the local data, and updates the value of the client data version number to the value of local data version number.

The client can delete the internally stored client synchronization data and meanwhile save the local data sent from the backup server. In addition, the client also needs to update the value of the client data version number (e.g. 201201010100) to the value of the new local data version number (e.g. 201201021154)

To sum up, by using a version number mechanism maintained by the backup server, the data synchronization method provided in example II can manage the backup data located on the backup server and the client synchronization data at the client. In this way, it avoids the synchronization disorder that might be caused in the synchronization process of multiple devices to one backup server, and ensures that data on multiple devices of a user can be synchronized to a same backup server. Therefore, it ensures overall consistency of the data, even if the user is using the multiple devices across platforms. By different synchronization modes, the method of data synchronization provided in example II also achieves the effect of reducing data traffic when sending the client backup data to the backup server.

### Example III

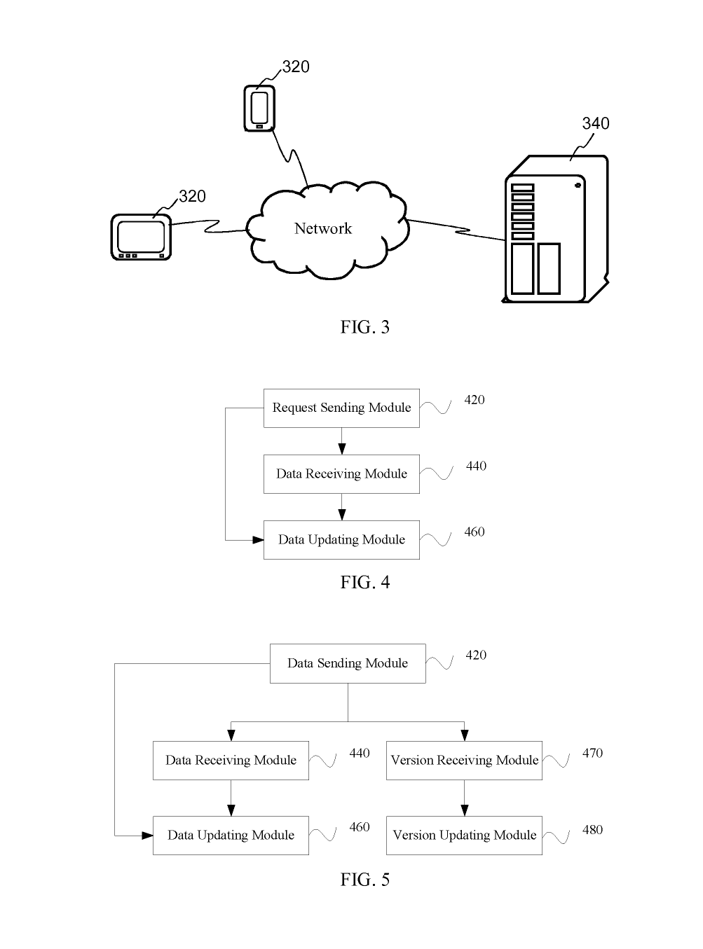

Referring to FIG. 3, it illustrates a structural schematic diagram of a system of data synchronization provided in example III of the present disclosure. The data synchronization system may include a client 320 and a backup server 340.

The client 320 sends a synchronization request to the backup server; the synchronization request includes a client data version number and client synchronization data.

The backup server 340 receives the synchronization request sent from the client 320 and determines whether the client data version number is consistent with a local data version number. If the client data version number is consistent with the local data version number, then local data is updated according to the client synchronization data; and if the client data version number is not consistent with the local data version number, then a local data version number and local data are sent to the client.

To sum up, by using a version number mechanism maintained by the backup server, the data synchronization method provided in example III can manage the backup data on the backup server and the client synchronization data at the client. In this way, it avoids synchronization disorder that might be caused in the synchronizing process of multiple devices to one backup server, and ensures that the data in multiple devices of a user can be synchronized to a same backup server. Therefore it ensures overall consistency of data, even if the user is using the multiple devices across different platforms,

### Example IV

To elaborate more on the client provided in example II, please refer to FIG. 4, which illustrates a structural block diagram of the client provided in example W of the present disclosure. The client can be used in the data synchronization system provided in example III of the present disclosure and the client may include a request sending module 420, a data receiving module 440 and a data updating module 460.

The request sending module 420 is configured to send a synchronization request to a backup server. The synchronization request data includes a client version number and client synchronization data.

The data receiving module 440 is configured to receive the local data version number and local data sent from the backup server.

The data updating module 460 is configured to delete the client synchronization data sent from the request sending module 420, save the local data received by the data receiving module 440, and update the value of the client data version number to the value of the local data version number received by the data receiving module 440.

More specifically, the request sending module 420 is configured to send a synchronization request to the backup server. The synchronization request includes a client version number and client synchronization data. The client synchronization data includes synchronization data, and each piece of the synchronization data includes data identification, a synchronization mode and synchronization content.

The synchronization mode includes any one of the following modes: an adding mode, configured to add content corresponding to the data identification according to the synchronization content; a modifying mode, configured to modify the content corresponding to the data identification according to the synchronization content; a deleting mode, configured to delete the content corresponding to the data identification according to the synchronization content; and a maintaining mode, configured to maintain the content corresponding to the data identification unchanged.

FIG. 5 illustrates another structural block diagram of the client provided in example IV of the present disclosure. Referring to FIG. 5, the client may include a request sending module 420, a data receiving module 440 and a data updating module 460. The client may also include a version receiving module 470 and a version updating module 480, in which the version receiving module 470 is configured to receive a new local data version number, and the version updating module 480 is configured to update the value of client data version number to the value of the new local data version number.

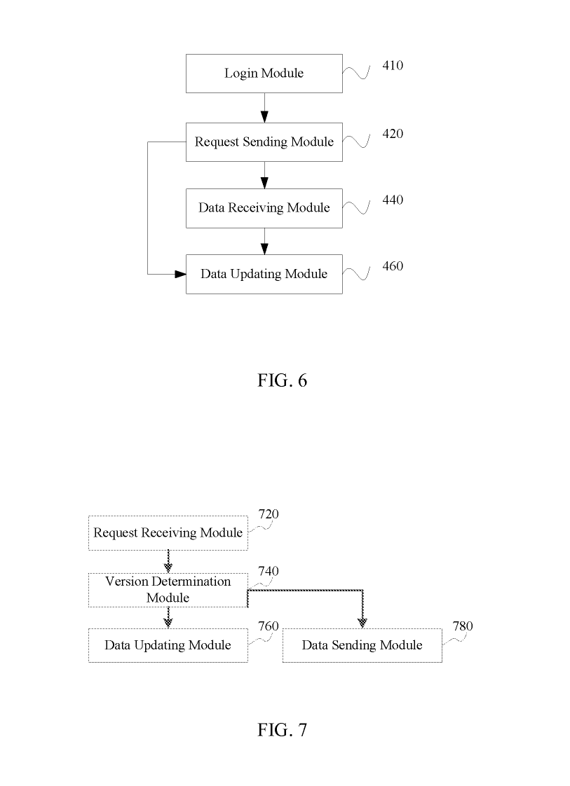

FIG. 6 illustrates another structural block diagram of the client provided in example IV of the present disclosure. Referring to FIG. 6, the client may include a request sending module 420, a data receiving module 440 and a data updating module 460. The client may also include a login module 410 to use preconfigured authentication information to log into the backup server.

To sum up, by using a version number mechanism maintained by the backup server, the client provided in example IV can manage the backup data on the backup server and the client synchronization data at the client. In this way, it avoids synchronization disorder that might be caused in the synchronization process of multiple devices to one backup server, and ensures that the data in multiple devices of a user can be synchronized to a same backup server. Therefore, it ensures overall consistency of the data, even if the user is using the multiple devices across platforms.

### Example V

To elaborate more on the backup server provided in the example III, please refer to FIG. 7 which illustrates a structural block diagram of the backup server provided in example V of the present disclosure. The backup server could be used in the data synchronization system provided in example III. The backup server includes a request receiving module 720, a version determination module 740 and a data updating module 760 and a data sending module 780.

The request receiving module 720 is configured to receive a synchronization request from a client. The synchronization request includes a client data version number and client synchronization data.

The version determination module 740 is configured to determine whether the client data version number is consistent with the local data version number.

The data updating module 760 is configured to update local data according to the client synchronization data when the client data version number is consistent with the local data version number.

The data sending module 780 is configured to send the local data version number and the local data to the client when the client data version number is not consistent with the local data version number.

More specifically, the data updating module 760 is configured to update the backup data of the local data according to the synchronization mode of each piece of synchronization data in the client synchronization data. The local data includes backup data, and each piece of the backup data includes data identification and the content corresponding to the data identification.

FIG. 8 illustrates another structural block diagram of the backup server provided in example V of the present disclosure. Referring to FIG. 8, the backup server may include a request receiving module 720, a version determination module 740, a data updating module 760 and a data sending module 780. The backup server may also include a version generation module 770 as shown in FIG. 8, in which the version generation module is configured to generate a new local data version number and send the new local data version number to the client.

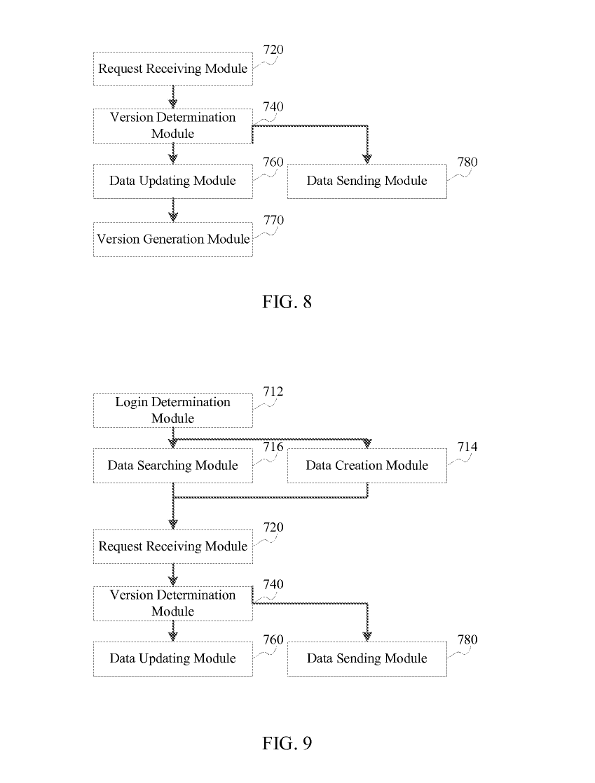

FIG. 9 illustrates another structural block diagram of the backup server provided in example V of the present disclosure. Referring to FIG. 9, the backup server may include a request receiving module 720, a version determination module 740, a data updating module 760 and a data sending module 780. The backup server may also include a login determination module 712, a data creation module 714 and a data searching module 716, in which the login determination module 712 is configured to determine whether this is the first login of the client; the data creation module 714 is configured to create a local data version number and local data corresponding to the preconfigured authentication information when the login determination module 712 determines that this is the first login of the client; the data searching module 716 is configured to search the corresponding local data version number and local data according to the preconfigured authentication information when the login determination module 712 determines that this is not the first login of the client.

To sum up, by using a version number mechanism maintained by the backup server, the backup server provided in example V manages the backup data in the backup server and the client synchronization data at the client. In this way, it avoids data synchronization disorder that might be caused in the synchronization process of multiple devices to one backup server, and ensures that the data in multiple devices of a user can be synchronized to a same backup server. Therefore, it ensures overall consistency of the data, even if the user is using the multiple devices across different platforms.

It should be noted herein that the division of the functional modules is used only in the examples to illustrate the process of data synchronization executed by the aforementioned data synchronization system, client and backup server provided in the examples. In actual applications, these functions may be assigned to and completed by different functional modules as needed. That is, the internal structure of the apparatus is divided into different functional modules to complete all or part of the aforementioned functions. In addition, the aforementioned data synchronization system, client and backup relate to the same idea, and the specific implementation process is detailed in method example, which will not be further elaborated herein.

The sequence numbers used to number the aforementioned examples of the present disclosure are for description purpose only, and do not indicate merits of the examples.

Those skilled in the art can understand and realize that all or part of the steps of the examples of the present disclosure may be conducted by using hardware or by using programs to command relevant hardware; the programs may be stored in a computer-readable storage medium, and the computer-readable storage medium could be ROM, disc or CD. The aforementioned examples of the present disclosure are preferred examples, and are not intended to limit the present disclosure. Any modifications, equivalent replacement, improvement etc. within the spirit and principles of the present disclosure shall be included in the scope of protection of the present disclosure.

What is claimed is:

1. A method of data synchronization, comprising:
sending a synchronization request to a backup server by a client, the synchronization request including a client data version number and client synchronization data;
receiving the synchronization request and determining whether the client data version number is consistent with a local data version number by the backup server;
updating local data according to the client synchronization data on condition that the client data version number is consistent with the local data version number; and
sending the local data version number and the local data to the client on condition that the client data version number is not consistent with the local data version number.

2. The method of data synchronization according to claim 1, wherein the client synchronization data comprises:
synchronization data, comprising data identification, a synchronization mode and synchronization content;
wherein the synchronization mode comprises any one of the following modes:
an adding mode, to add content corresponding to the data identification according to the synchronization content;
a modifying mode, to modify the content corresponding to the data identification according to the synchronization content;
a deleting mode, to delete the content corresponding to the data identification according to the synchronization content; and
a maintaining mode, to maintain the content corresponding to the data identification unchanged.

3. The method of data synchronization according to claim 2, wherein updating the local data according to the client synchronization data comprises:
updating backup data in the local data according to the synchronization mode of the client synchronization data;
wherein the local data comprises the backup data, and the backup data comprises data identification and content corresponding to the data identification.

4. The method of data synchronization according to claim 3, wherein after updating the local data according to the client synchronization data, the method further comprises:
generating a new local data version number and sending the new local data version number to the client by the backup server; and
receiving the new local data version number and updating a value of the client data version number to a value of the new local data version number by the client.

5. The method of data synchronization according to claim 1, wherein after sending the local data version number and the local data to the client, the method further comprises:
receiving the local data version number and the local data sent from the backup server by the client; and
deleting the client synchronization data, saving the local data, and updating a value of the client data version number to a value of the local data version number by the client.

6. The method of data synchronization according to claim 1, wherein before sending the synchronization request to the backup server by the client, the method further comprises:
using preconfigured authentication information to log into the backup server by the client;
determining whether this is a first login of the client by the backup server;
creating the local data version number and the local data corresponding to the preconfigured authentication information on condition that the backup server determines that this is the first login of the client; and
searching for the local data version number and the local data corresponding to the preconfigured authentication information on condition that the backup server determines this is not the first login of the client.

7. A client, comprising:
a request sending module, to send a synchronization request to a backup server; the synchronization request comprising a client data version number and client synchronization data;
a data receiving module, to receive a local data version number and local data sent from the backup server; and
a data updating module, to delete the client synchronization data, save the local data, and update a value of the client data version number to a value of the local data version number.

8. The client according to claim 7, wherein:
the request sending module is configured to send the synchronization request to the backup server; the synchronization request comprising the client data version number and the client synchronization data; the client synchronization data comprising data identification, a synchronization mode and synchronization content;
wherein the synchronization mode comprises any one of the following modes:
an adding mode, to add content corresponding to the data identification according to the synchronization content;
a modifying mode, to modify the content corresponding to the data identification according to the synchronization content;
a deleting mode, to delete the content corresponding to the data identification according to the synchronization content; and
a maintaining mode, to maintain the content corresponding to the data identification unchanged.

9. The client according to claim 8, wherein the client further comprises a version receiving module and a version updating module;
the version receiving module is configured to receive a new local data version number; and
the version updating module is configured to update the value of the client data version number to a value of the new local data version number.

10. The client according to claim 7, wherein the client further comprises:
a login module, to use preconfigured authentication information to log into the backup server.

11. A backup server, comprising:
a request receiving module, to receive a synchronization request from a client; the synchronization request comprising a client data version number and client synchronization data;
a version determination module, to determine whether the client data version number is consistent with a local data version number;
a data updating module, to update local data according to the client synchronization data on condition that the client data version number is consistent with the local data version number; and
a data sending module, to send the local data version number and the local data to the client on condition that the client data version number is not consistent with the local data version number.

12. The backup server according to claim 11, wherein:
the data updating module is configured to update backup data in the local data according to a synchronization mode of the client synchronization data;
wherein the local data comprises the backup data, and the backup data comprises data identification and content corresponding to the data identification.

13. The backup server according to claim 11, wherein the backup server further comprises:
a version generation module, to generate a new local data version number and send the new local data version number to the client.

14. The backup server according to claim 11, wherein the backup server further comprises:
a login determination module, a data creation module, and a data searching module; wherein
the login determination module is configured to determine whether this is a first login of the client;
the data creation module is configured to create the local data version number and the local data corresponding to the preconfigured authentication information on condition that the backup server determines that this is the first login of the client; and
the data searching module is configured to search for the local data version number and the local data corresponding to the preconfigured authentication information on condition that the backup server determines that this is not the first login of the client.

15. The client according to claim 8, wherein the client further comprises:
a login module, to use preconfigured authentication information to log into the backup server.

16. The client according to claim 9, wherein the client further comprises:
a login module, to use preconfigured authentication information to log into the backup server.

17. The backup server according to claim 12, wherein the backup server further comprises:
a login determination module, a data creation module, and a data searching module; wherein
the login determination module is configured to determine whether this is a first login of the client;
the data creation module is configured to create the local data version number and the local data corresponding to the preconfigured authentication information on condition that the backup server determines that this is the first login of the client; and
the data searching module is configured to search for the local data version number and the local data corresponding to the preconfigured authentication information on condition that the backup server determines that this is not the first login of the client.

18. The backup server according to claim 13, wherein the backup server further comprises:
a login determination module, a data creation module, and a data searching module; wherein
the login determination module is configured to determine whether this is a first login of the client;
the data creation module is configured to create the local data version number and the local data corresponding to the preconfigured authentication information on condition that the backup server determines that this is the first login of the client; and
the data searching module is configured to search for the local data version number and the local data corresponding to the preconfigured authentication information on condition that the backup server determines that this is not the first login of the client.
